(19) United States
(12) Patent Application Publication
(10) Pub. No.: US 2017/0017898 A1
(43) Pub. Date: Jan. 19, 2017

(54) Method of Determining Working Memory Retrieval Through Finite Automata and Co-Prime Numbers

(71) Applicant: Bradley Hertz, Mount Vernon, NY (US)

(72) Inventor: Bradley Hertz, Mount Vernon, NY (US)

(21) Appl. No.: 14/949,795

(22) Filed: Nov. 23, 2015

Related U.S. Application Data
(60) Provisional application No. 62/192,364, filed on Jul. 14, 2015.

(51) Int. Cl. G06N 99/00

(52) U.S. Cl. CPC G06N 99/005

(57) ABSTRACT

A method of determining working memory has the steps of i) sensory data being received; ii) the sensory data being converted into short term data; iii) the short term data dissipating except for data that is rehearsed to form remaining data; iv) the remaining data being taught to a perceptron in a supervised fashion; v) computing mathematical relationships of average values of sentences of the remaining data; and vi) computing assignments on relative prime number values of the remaining data, wherein the assignments are connected to the perceptron. In an embodiment, relative prime number values represent each of the letters of the English language. In another embodiment, the multi-store model of memory is used as an automata. The sensory memory may receive data on sensory input, and information in textual form may be presented in a supervised learning format to the perceptron.

### CROSS-REFERENCE TO RELATED APPLICATION

The present application priority to U.S. Provisional Patent Application No. 62/192,364 filed on Jul. 14, 2015, entitled “A method of determining working memory retrieval through finite automata and co-prime numbers” the entire disclosure of which is incorporated by reference herein.

### BACKGROUND OF THE INVENTION

1. Field of Invention

This invention relates to a method of quantifying working memory through finite automata and co-prime numbers.

2. Description of Related Art

The finite automata type of representation was originally developed by Atkinson-Schiffrin in 1968. Using prime numbers and the formulas for average letters per syllable, average syllables per word, and average words per sentence, the environmental stimuli(auditory and visual), is encountered by the subject. This data is analyzed by a Multi-layered, back-propagated perceptron.

### SUMMARY OF THE INVENTION

A method of determining working memory has the steps of i) sensory data being received; ii) the sensory data being converted into short term data; iii) the short term data dissipating except for data that is rehearsed to form remaining data; iv) the remaining data being taught to a perceptron in a supervised fashion; v) computing mathematical relationships of average values of sentences of the remaining data; and vi) computing assignments on relative prime number values of the remaining data, wherein the assignments are connected to the perceptron.

In an embodiment, relative prime number values represent each of the letters of the English language. In another embodiment, the multi-store model of memory is used as an automata. The sensory memory may receive data on sensory input, and information in textual form may be presented in a supervised learning format to the perceptron.

Standardized numbers between 0 and 1 may be used for the representation, and/or may be used for the sampling using a tanh function. Standardization may be used for the sampling using a Sigmoid function. In an embodiment, text of average values of word, syllable, and letter frequency are used, and relatively prime number theory for calculations represent mathematical relationships among relatively prime numbers. Also, the automaton may be a Pushdown Automaton, or may be a Universal Turing Machine.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic diagrams of presently preferred embodiments of the memory retrieval method, according to an embodiment of the present invention;

FIG. 2 is a schematic diagram showing the formation of short and long-term memory;

FIG. 3 shows an embodiment of the multilayer perceptron;

FIG. 4 shows another embodiment of the multilayer perceptron; and

FIG. 5 is a table of assignment of relatively prime numbers to English letters.

### DETAILED DESCRIPTION OF PREFERRED EMBODIMENTS

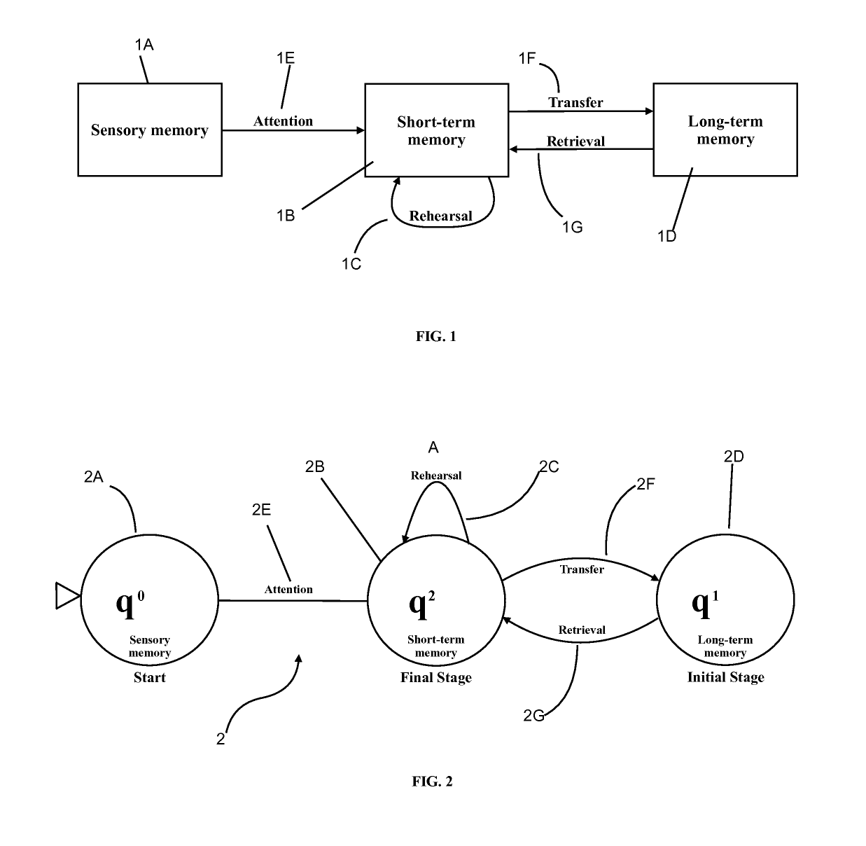

Preferred embodiments of the present invention and their advantages may be understood by referring to FIGS. 1-5 wherein like reference numerals refer to like elements.

FIG. 1 is a schematic diagram of a presently preferred embodiment for a method of memory retrieval.

List of Components:
Atkinson-Schifrin working memory.
Finite Automata of 1.
Mathematical relationships: averages amongst parts of sentences.
Schematic of multilayer perceptron.
Mathematical relationships among relatively prime numbers.
English Language relative prime number assignments.

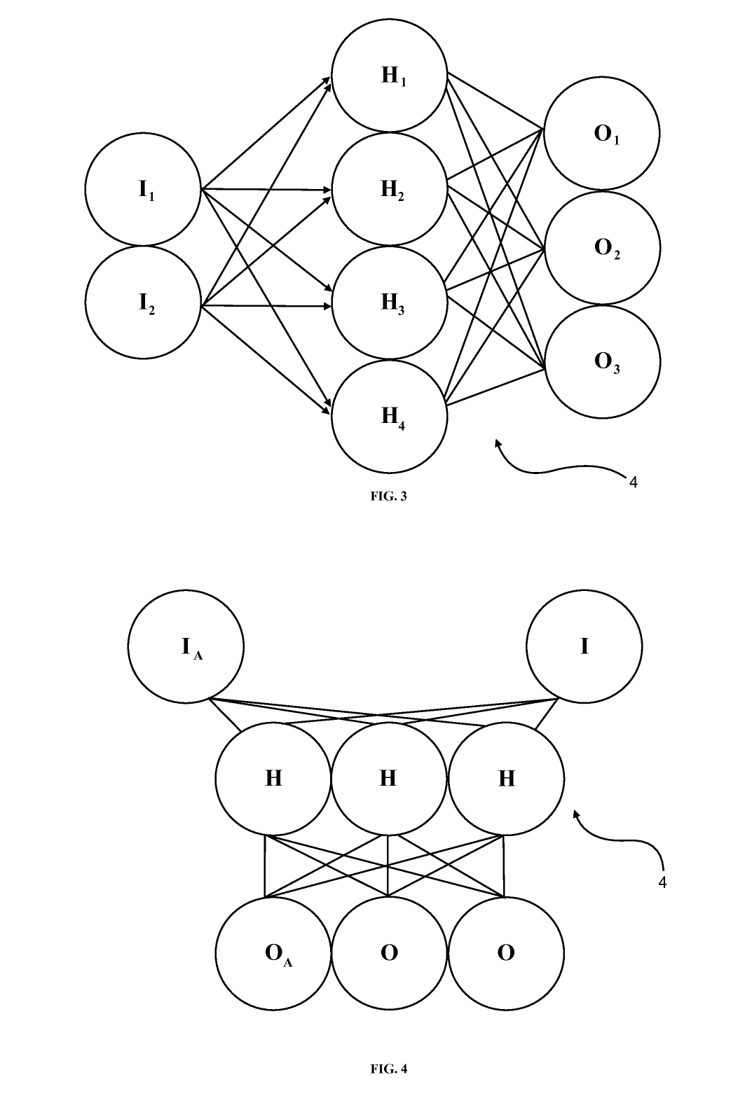

With reference to FIG. 1, the computer connects with the back propagated, multilayered perceptron 4. A schematic of the memory model 1 of Atkinson-Schiffrin is shown. The Atkinson-Schiffrin Memory Model can be pictured as a general overall context synopsis that periodically makes references to the other drawings. It illustrates how sensation, or stimuli 1A, act on the working, or short term memory 1B. However, this environmental stimuli and sensations transfer into long term memory 1D by transfer 1F, and are retrieved for iterative working memory or rehearsal 1C through retrieval 1G. This is the same process that occurs in FIG. 2 as reflected in the symmetrical finite automata diagram. This is the simplest finite automata that can be shown. 1C, 1F, 1E, and 1G all connect with perceptron 4 and perform special mathematical operations, consisting of mathematical relationships of average values of sentences, and mathematical operations on relative prime number values. The assignments are also connected to perceptron 4 and 1C, 1F, 1E, and 1G because it is the inventors use of relative prime number values for all 26 letters of the English language. A symmetrical like rendering of the Atkinson-Schiffrin memory model is depicted as a finite automata in FIG. 2.

In operation, the computer initializes the perceptron 4. The perceptron is an algorithm for supervised learning of binary classifiers: functions that can decide whether an input (represented by a vector of numbers) belongs to one class or another. It is a type of linear classifier, i.e. a classification algorithm that makes its predictions based on a linear predictor function combining a set of weights with the feature vector. The algorithm allows for online learning, in that it processes elements in the training set one at a time. The multi-store model of memory is used as an automata 2. An automata is a finite representation of a formal language that may be an infinite set. Automata are often classified by the class of formal languages they are able to recognize.

The sensory memory 1A receives data on sensory input received from one or more sensors. Information in textual form is presented in a supervised learning format to perceptron 4, which is used to learn how to extrapolate and normalize discrete text data into shorter forms that can be visualized and understood in FIG. 1, for example.

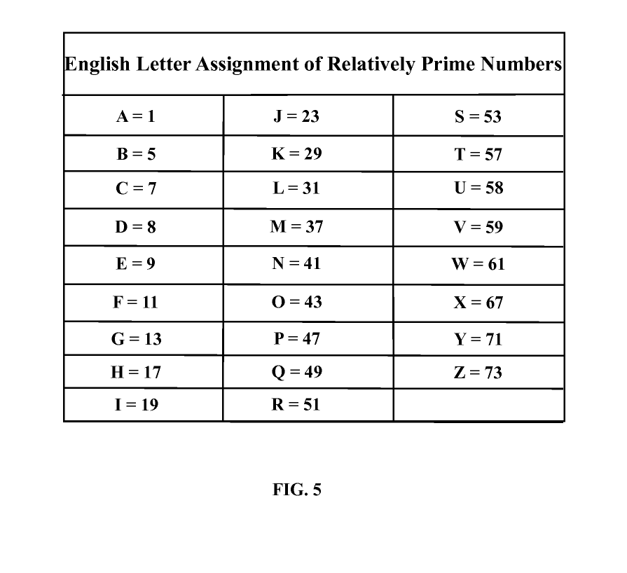

In one embodiment, the machine learning perceptron has error-correcting to near zero, and data need not be imputed or interpolated. In another embodiment, missing data is imputed or interpolated. The Excel formula=NA( ) may be useful to interpolate the missing data. Use of text of average values of word, syllable, and letter frequency, and relatively prime number theory for calculations representing mathematical relationships among relatively prime numbers. Short-term memory 1B is the next phase for sensory data. Short term memory 1B dissipates, except for rehearsal, 1C. Short term memory is the sensory data, 1A, with the higher level of rehearsal (iteration), 1C, and consequently, lower rate of short term memory dissipation, with less missing data. These values being taught to the perceptron 4, in a supervised fashion. Memory dissipation, 1F is transferred into 1D, long term memory, and this value is equal to integer 1B/1C. Memory data 1E is retrieved from long term memory to replace transferred data 1F. Calculations explain the concepts of relative prime number theory. These calculations will primarily be multiplication and integer division. Finite automata 2 demonstrates the automata symmetry of the multi store model, and explains the similarity of short-term memory 1B and 2B, the end point areas of the models. FIG. 5 shows an example choice of English Language relative prime number representations for all 26 letters of the English alphabet. In alternative embodiments, the other methods are to use a Pushdown Automaton and a Universal Turing Machine.

In an embodiment of the present invention, the sensory memory, 1A and attention, 1E, can be inputted with the free data science and statistical tool, ADAMsoft. This tool imputed and interpolated the data, with additional processes. In this manner this data could be greatly extrapolated, cross-validated and reduced to the other dimensions sizes—1F, 1G, and 1C.

FIG. 3 is a generalized embodiment of a multiple layer perceptron with two inputs, one hidden layer, with 4 inputs and 3 outputs. Inputs represent the stimuli, which are greatly expanded in length and missing place holder values in order to make the readings as accurate as possible. The hidden layer is adjusted during training and testing, and it fine-tunes the output to match the inputs precisely. The outputs could be a representative sample of the values, according to discrete data normalization technique.

FIG. 4 is another embodiment of the multilayer perceptron. However, it also has only one hidden layer with three, as opposed to two nodes. This is meant to demonstrate that different training or data can generate different results during training and/or testing.

FIG. 5 is a hypothetical assignment of random values of letters of the English language to be used for multilayer perceptron training and testing. In a preferred embodiment, standardized numbers between 0 and 1 are used. This same standardization may be used for the sampling from FIG. 1C, using either the tanh or Sigmoid function.

The system may be used for processing stimuli. Other uses are Library retrieval methods, personal data retrieval, book and literary searches, medical devices for improving patients' short term memories. Alternative uses include information retrieval, in an informatics context. Additionally, the Natural Language Processing area can find this invention useful.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method of determining working memory comprising the following steps:
a. sensory data being received;
b. the sensory data being converted into short term data;
c. the short term data dissipating except for data that is rehearsed to form remaining data;
d. the remaining data being taught to a perceptron in a supervised fashion;
e. computing mathematical relationships of average values of sentences of the remaining data;
f. computing assignments on randomly assigned integer values from 1-27, wherein 1-26 represent A-Z, while value 27 represents a null value; and
g. relative prime number values of the remaining data, wherein the assignments are connected to the perceptron.

2. The method of claim 1 wherein relative prime number values represent each of the letters of the English language.

3. The method of claim 1 wherein the multi-store model of memory is used as an automata.

4. The method of claim 1 wherein the sensory memory receives data on sensory input.

5. The method of claim 1 wherein information in textual form is presented in a supervised learning format to the perceptron.

6. The method of claim 1 wherein standardized numbers between 0 and 1 are used for the representation.

7. The method of claim 1 wherein standardization may be used for the sampling using a tanh function.

8. The method of claim 1 wherein standardization may be used for the sampling using a Sigmoid function.

9. The method of claim 1 wherein text of average values of word, syllable, and letter frequency are used, and relatively prime number theory for calculations represent mathematical relationships among relatively prime numbers.

10. The method of claim 1 wherein the automaton is a Pushdown Automaton.

11. The method of claim 1 wherein the automaton is a Universal Turing Machine.
